(19) United States
(12) Patent Application Publication
(10) Pub. No.: US 2022/0277392 A1
(43) Pub. Date: Sep. 1, 2022

(54) METHOD FOR TRADING CRYPTOCURRENCIES

(71) Applicant: DAIMLER AG, Stuttgart (DE)

(72) Inventors: Viktor FRIESEN, Karlsruhe (DE); Micha KOLLER, Pliezhausen (DE); Hubert REHBORN, Sindelfingen (DE)

(21) Appl. No.: 17/629,060

(22) PCT Filed: Jul. 13, 2020
(86) PCT No.: PCT/EP2020/069730

§ 371 Date: Jan. 21, 2022

(30) Foreign Application Priority Data
Jul. 23, 2019 (DE) 10 2019 005 116.5

(51) Int. Cl. G06Q 40/04

(52) U.S. Cl. CPC G06Q 40/04

(57) ABSTRACT

A method for trading cryptocurrencies in a vehicle involves providing the vehicle with a control module for trading in the cryptocurrencies. The control module checks each desired trading action based on stored and/or retrieved information relating to local legal provisions. Only legally compliant trading actions are permitted.

### BACKGROUND AND SUMMARY OF THE INVENTION

Exemplary embodiments of the invention relate to a method for trading cryptocurrencies in a vehicle with an Internet connection and an input/output interface.

Trading cryptocurrencies from a vehicle is known in principle from DE 10 2018 006 478 A1, wherein, according to this document, an application program stored on a vehicle key is involved in the payment process and comprises a private digital key. Other methods and the use of other input/output and verification means are also conceivable.

In practice, it is now the case that trading of cryptocurrencies from the vehicle is in principle desired and possible. However, it is also the case that the regulations regarding the trading of cryptocurrencies differ greatly in different countries. Depending on the country, the legal framework for the possession and trading of cryptocurrencies differs. In some countries, possession and trading are prohibited by law, while in others possession is permitted but trading is not. Still other countries have no restrictions on trading cryptocurrencies. The fact is that the legal regulations for trading in cryptocurrencies are in a state of change almost everywhere, and so the current state of affairs can change frequently.

With regard to sources, reference can be made to the country-specific legislation on cryptocurrencies, as can be found, for example, at https://coin.dance/poli.

Another source is: Deutscher Bundestag (German Federal Parliament), Einzelfragen zur Regulierung and zur Nutzung von Kryptowährungen (Questions on the Regulation and Use of Cryptocurrencies), https://www.bundestag.de/resource/blob/547154/f316613869fiff44f54cd6eaaa053f1b7/wd-4-021-18-pdf-data.pdf.

Even if trading in cryptocurrencies is generally permitted in a country, there may be special regulations on various trading actions regarding cryptocurrency classes or individual cryptocurrencies. For example, the class of initial offerings of cryptocurrencies, Initial Coin Offerings or ICOs for short, is specially regulated in many countries. The process is comparable to the IPO of a public limited company. The same applies to so-called “Security Token Offerings”, or STOs for short, which are subject to even stricter regulation than ICOs. Special regulations may also apply to initial offerings specific to trading platforms, which are referred to as Initial Exchange Offerings or IEOs for short.

All in all, the multitude of regulations and country-specific peculiarities of these regulations is very unmanageable. If someone wants to trade in cryptocurrencies in their vehicle, they would have to consider and check in advance for each trading action to what extent it is permissible in the particular country in order to act in accordance with the law. This is associated with an extraordinarily high level of effort, and mistakes can easily be made so that legal regulations are not adhered to, with the relevant country-specific sanctions for this.

Exemplary embodiments of the present invention are directed to ensuring, in addition to the trading of cryptocurrencies in vehicles as known in principle from the prior art, that the various temporal-spatial restrictions are observed and that the trading actions carried out from the vehicle by a user are in conformity with the law.

The method according to the invention provides for trading in cryptocurrencies from the vehicle via an Internet connection of the vehicle and an input/output interface of the vehicle. According to the invention, a control module is provided for trading in the cryptocurrencies and checks each desired trading action based on stored and/or retrieved information relating to local legal provisions, wherein only trading actions complying with the law are permitted. The control module thus assumes the function of a filter to ensure that the only desired trading actions that are carried out and transmitted to the Internet are those that are also permitted locally in the area of use of the vehicle. The user of the vehicle is thus relieved in a very comfortable way by the control module and can rely on the fact that only legally compliant trading actions are permitted and that the control module blocks all other trading actions that the driver wanted to perform.

According to a very advantageous refinement of the method, it can be provided that the locally applicable legal provisions are retrieved from a backend server via a communication unit of the vehicle according to the location of the vehicle. Such a communication with a backend server, which manages the relevant applicable legal provisions accordingly and makes them available to the control module for filtering the trading actions, has the key advantage of being constantly up-to-date. Since an Internet connection is necessary anyway for trading with the cryptocurrency, it can also be used for querying the relevant locally applicable legal provisions based on the position determined, for example, via a GPS module of a navigation system of the vehicle. This query ensures that only the current and locally applicable legal provisions are actually taken into account.

In order to minimize data traffic and any associated costs, an alternative variant of the method according to the invention can also provide for the locally applicable legal provisions to be retrieved in accordance with the location of the vehicle, temporarily stored and updated from time to time, in the event of changes to the law and/or if the vehicle crosses a border. This reduces the amount of data traffic across the vehicle's communication unit. The legal provisions, once retrieved, can be temporarily stored in the vehicle. Now, for example, from time to time, or in the event of a change in the law, the existence of which can be disseminated, for example, via signals such as radio signals or the like, a new retrieval can be made. Ideally, this means that the currently valid provisions are always available without having to communicate constantly with a backend server about these provisions. Even in the event of a border crossing, which is typically accompanied by a change in the provisions, a new retrieval takes place so that the provisions applicable in the country now present are available and can be used as a filter for the legality of the desired trading actions in the method according to the invention.

Another possibility now is that the locally applicable legal provisions are preset and stored according to the destination country of the vehicle delivery. With this option, which can be used as an alternative to a current retrieval and/or a retrieval and intermediate storage, it is the case that, for example, the corresponding legal provisions can be preset and stored during production, export, delivery, or even a workshop visit. This has the key advantage that the vehicle is configured in conformity with the law for the particular destination country. In this way, for example, conceivable import restrictions can be observed so that only those vehicles enter a country that are also able to guarantee the provisions applicable there when trading cryptocurrencies from the vehicle.

According to an extraordinarily favorable embodiment of the described variants of the method according to the invention with a communication connection, this communication connection is secured via an encryption that cannot be read by the user. In addition, or alternatively, if a memory is present, it can also be secured via an encryption that cannot be read by the user. Such an encryption can, for example, be a cryptographic encryption. This ensures that the settings cannot be changed or manipulated by a user or also by third parties, such as service providers, in order to be able to carry out such actions, for example, despite the system implemented in the vehicle for filtering out illegal trading actions. A service workshop holding the key may then nevertheless be able to access the data, in particular in the memory, e.g., in order to update it or adapt it accordingly when selling the vehicle to another country.

An extraordinarily favorable further refinement of the method according to the invention provides that the user is informed about rejected trading actions. The user can thus recognize which trading actions are not permissible and, even before the user looks at the user's order book on the relevant platform, can determine that this action has been rejected due to his current location or the vehicle configured for the destination country in which the user is located.

A very advantageous refinement of this variant of the method according to the invention can provide that in the case of a rejected trading action, if the same trading action is permissible in a neighboring country, in particular in a neighboring country which lies, for example, within a predefined radius of up to 100 or 200 kilometers, a route to this neighboring country is suggested to the user via a navigation device of the vehicle. Thus, together with the rejection of the desired trading action, the user is simultaneously shown a way out in order to be able to carry out this trading action after all, for example by accepting a journey to a neighboring country in which this trading action is permissible.

Basically, when the user is informed about rejected trading actions, the user gradually acquires knowledge of the local legal provisions without having to familiarize themselves with the local legal provisions. According to a very advantageous refinement of the method according to the invention, it can be additionally provided that the trading actions carried out by the user in question are managed on a personalized basis on a backend server, wherein the user is informed about legal changes to his frequently carried out trading actions. The user can, for example, make up for rejected desired trading actions if these become permissible at his location due to a change in the legal situation without the user undertaking a journey that crosses a border. This also represents a particularly advantageous increase in user comfort for the user of the vehicle with the implemented method according to the invention.

### BRIEF DESCRIPTION OF THE DRAWING FIGURES

Further advantageous configurations of the method according to the invention will also become clear from the exemplary embodiment which is described in more detail below with reference to the figures.

Specifically:

FIG. 1 shows a schematic representation of a vehicle viewed from the inside; and

FIG. 2 shows a schematic detail of a map.

### DETAILED DESCRIPTION

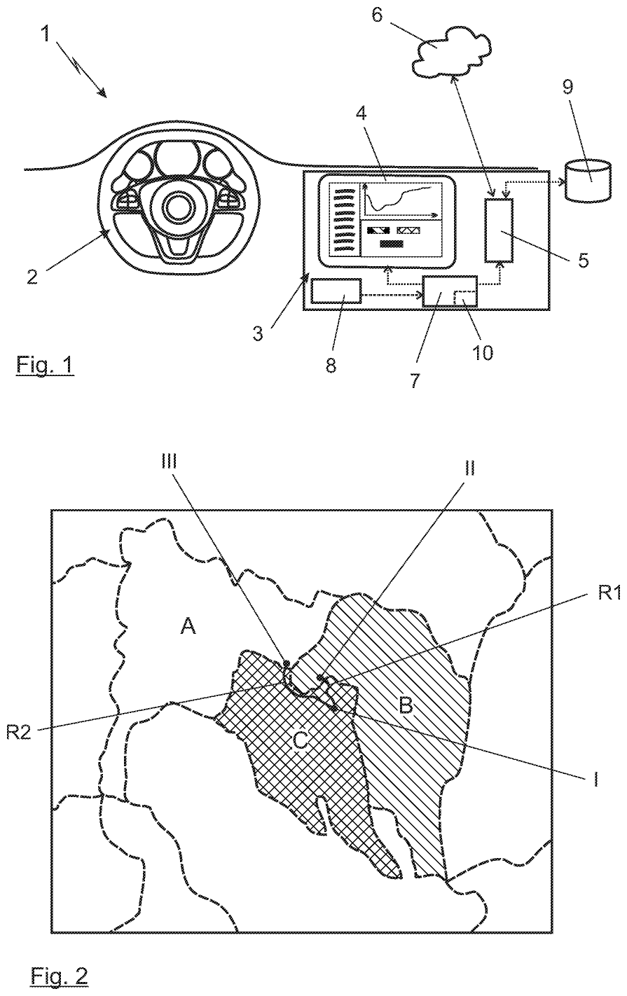

In the illustration in FIG. 1, a vehicle 1 is shown, purely by way of example, from the perspective, for example, of a person driving the vehicle. In addition to a steering wheel 2, a multifunction unit 3 is shown here, which has, for example, a touchscreen 4 as an input/output interface 4. The touchscreen 4 can be used, for example, to control a media service or also a navigation system (not explicitly shown here) implemented in the vehicle. It is also the case that cryptocurrencies can be traded via the touchscreen 4 as input/output interface. A user of the vehicle 1 can communicate via the multifunction unit 3, which has a communication unit 5 with the Internet 6, exemplified here as a cloud, and can thus trade in cryptocurrencies, among other things.

The illustration in FIG. 1 shows a purely exemplary module for trading cryptocurrencies, such as Bitcoin, Ethereum, Ripple, Litecoin, EOS, or similar. A corresponding trading platform can be selected for this, for example Kraken, Binance, Bitfinex, or similar. Such a platform is shown purely as an example. The user can evaluate various trading actions, for example buying and selling certain cryptocurrencies, participating in initial offerings of cryptocurrencies of various types, for example ICO, STO, IEO or the like. In the context of a purchase or sale, different order types, for example market, limit, stoploss or similar, can be selected in a known manner, as is usual on such platforms. Order books (Asks, Bits, Spread) for a previously selected trading pair of cryptocurrencies can also be displayed on such a trading platform and executed as trading actions, wherein the display can take place, for example, in a display form aggregated to a certain number of decimal places. As also shown on the touchscreen 4 in the representation of FIG. 1, a price trend of the cryptocurrency on the trading platform can be called up as a diagram or the history of the most recent trading actions on particular trading platform can be called up in a manner known per se. Via a correspondingly secure system, the trading actions or transaction requests are then executed accordingly via the APIs of the selected trading venue and the user is shown a corresponding confirmation of his purchase, sale or the like.

The user logs in to a central trading platform, for example, using a username and password. In order for his vehicle to participate in trading, the vehicle can then generate a wallet corresponding to the corresponding currency and display it to the driver, so that the transactions, which typically take place directly via a blockchain, can be realized from the vehicle.

As already mentioned at the outset, different legal regulations apply in different countries, in principle for trading with cryptocurrencies as such as well as specifically for trading with certain cryptocurrencies and for participation in certain initial offerings, such as ICO, STO or IEO. The illustration in FIG. 2 therefore shows an exemplary map on which three countries A, B and C are marked accordingly. In the embodiment example shown here, it should be the case that in country A there are virtually no restrictions on trading, while in country B there are restricted trading possibilities, so that, for example, certain types of initial issues are not permitted for participation in country B, while trading in cryptocurrencies per se, i.e., for example buying or selling the cryptocurrencies, is perfectly permissible. Country C has the strictest restrictions; in this country, for example, trading in certain cryptocurrencies may be completely prohibited.

The driver of the vehicle 1, by way of example, is now in the driver's hometown, designated I, in country C. For example, the driver wishes to trade a cryptocurrency that is not approved for trading in his country. It may be that the driver does not know this, as the regulations are very complex and vary greatly for different trading actions depending on the country. Furthermore, it is the case that the legislation on trading cryptocurrencies is in constant flux and changes very frequently. If the driver now tries to carry out the desired trading action, for example to buy a certain cryptocurrency, then a control module 7 comes into play, which filters and checks the desired trading actions for their legality. Such a trading action that does not comply with the law in country C would be restricted accordingly via the control module 7. This can be achieved, for example, by querying the location of the vehicle 1 via a GPS module 8, and the corresponding legal regulations, in this case those of country C, are taken into account in the filtering by the control module 7.

In principle, various possibilities are provided for this. The control module 7 can, for example, retrieve the current legal regulations from a backend server 9 via the communication unit 5. The communication is encrypted via a crypto key, for example, and is not accessible to the user, so that no manipulation can take place here, at least not with reasonable effort and not with a level of effort expendable by conventional users.

Alternatively, it may be envisaged that the corresponding locally applicable legal provisions are only retrieved from time to time. They can then be stored in a memory 10 in the control module 7, which can of course also be located elsewhere within the vehicle 1. This memory 10 is also protected accordingly, for example by means of cryptographic encryption, in order to exclude manipulation of the data in the memory here as well, so that the filtering cannot be influenced or cannot be influenced with reasonable effort.

Another possibility is that the memory 10 or an area within this memory 10 is preset according to the destination country of the vehicle, in this case country C, when the vehicle is delivered, for example at the end of production, when the vehicle is exported, when the vehicle is imported, or in a similar situation. This ensures that the legal provisions of country C are implemented in the memory 10 for vehicles delivered to country C, and that within country C only trading actions that are legal there are permitted by the control module 7.

The user of the vehicle 1 is now informed of a rejected or blocked trading action accordingly, so that the driver knows that the action he wanted has been rejected due to legal provisions. If the driver is, for example, in the vicinity of the border to another country in which precisely this trading action would be permissible, for example the trading desired by the driver with a certain cryptocurrency, then, in addition to the rejection of his desired trading action, a route can be suggested via a navigation system of the vehicle in order to reach, for example, a point II in country B or a point III in country A in which this action is permissible. If the action is of great importance to the user of the vehicle 1, the user can follow this route recommendation and, after crossing the border in accordance with the local provisions applicable there, can then carry out this desired action after all. For example, a limit distance can be predefined or also set individually by the driver, so that such a recommendation is only made if the route does not exceed a certain predefined length of, for example, 150 kilometers. Alternatively, this could also be set on the basis of a predicted journey time.

All in all, this creates a method which increases the convenience for a user when trading cryptocurrencies from his vehicle 1 accordingly, and at the same time ensures that the user does not have to worry, or does not have to worry in detail, about the legal regulations applicable at the user's location, or to changes to said regulations, which may occur very quickly.

In principle, a vehicle 1 preset for a destination country is permanently linked to this information. A change should not be made in this case in order not to be able to undermine import provisions, for example. In such a case, it can be provided that the corresponding data can be overwritten and changed, for example during a workshop visit, by authorized specialist personnel, in order to enable adaptation to changing legal provisions. Furthermore, it is of course possible to use other data in this variant as well, as soon as the vehicle has left its country of destination, in this case country C. As soon as the border is crossed, which can be determined via the GPS module 8, the legal provisions of, for example, country B or country A can be called up accordingly and applied alternatively in the control module 7 until the vehicle returns to its own country C.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for trading cryptocurrencies in a vehicle, the method comprising:
receiving, via an input/output interface of the vehicle, a request to trade a cryptocurrency;
checking, by a control module of the vehicle based stored or retrieved information relating to local legal provisions for trading cryptocurrencies, whether the request to trade the cryptocurrency complies with the local legal provisions for a current location of the vehicle,
wherein the request to trade is transmitted over an internet connection only when the request to trade the cryptocurrency complies with the local legal provisions for a current location of the vehicle

12. The method of claim 11, further comprising:
retrieving, via a communication unit of the vehicle, the local legal provisions for the current location of the vehicle from a back-end server.

13. The method of claim 12, the retrieved local legal provisions are stored and are updated responsive to changes in the local legal provisions or when the vehicle crosses a border between countries.

14. The method of claim 11, wherein the local legal provisions are preset and stored according to a destination country in which the vehicle is delivered.

15. The method of claim 14, further comprising:
determining that the vehicle is crossing a border from the destination country to another country;
retrieving locally applicable legal provisions for the another country; and
replacing the preset local legal provisions with the retrieved locally applicable legal provisions for the another country.

16. The method of claim 11, wherein the communication unit encrypts communications that cannot be read by a user of the vehicle.

17. The method of claim 14, wherein the local legal provisions are stored in an encrypted form that cannot be read by a user of the vehicle.

18. The method of claim 11, wherein a user of the vehicle is informed of trade that is rejected for not complying with the local legal provisions for a current location of the vehicle.

19. The method of claim 18, wherein, responsive to the trade being rejected for not complying with local legal provisions, the method further comprising:
determining that the trade complies with local legal provisions for a country neighboring the country in which the vehicle is located; and
outputting a route to the country neighboring the country in which the vehicle is located.

20. The method of claim 11, wherein, for a user requesting the trade, the user's trading actions are managed in a personalized manner on a back-end server, wherein the user is informed regarding legal changes to the user's trading actions.
